(19) United States
(12) Patent Application Publication
(10) Pub. No.: US 2024/0050299 A1
(43) Pub. Date: Feb. 15, 2024

(54) INCUBATOR AND PROCESS FOR REGULATING THE ENVIRONMENT OF THE INCUBATOR UTILIZING NEBULIZED WATER PARTICLES AND AIR

(71) Applicant: AHA, LLC, BLOOMFIELD, IN (US)

(72) Inventors: Robert E. Hoerter, Bloomfield, IN (US); William C. Arbaugh, II, New Albany, IN (US); Adrian B. Van Bakel, Isle of Palms, SC (US)

(21) Appl. No.: 18/493,238

(22) Filed: Oct. 24, 2023

Related U.S. Application Data
(63) Continuation-in-part of application No. 17/222,133, filed on Apr. 5, 2021, now Pat. No. 11,835,239.
Application No. 17/222,133 is a continuation-in-part of application No. 16/367,854, filed on Mar. 28, 2019, now Pat. No. 10,966,432.
(60) Provisional application No. 63/381,205, filed on Oct. 27, 2022.
(60) Provisional application No. 62/649,677, filed on Mar. 29, 2018.

(51) Int. Cl. A61G 11/00

(52) U.S. Cl. CPC A61G 11/00; A61G 2210/90; A61G 2203/46

(57) ABSTRACT

An infant incubator and a process for regulating an environment of an incubator. The incubator includes a chamber that is formed when a hood is secured to a base. The infant rests atop a variable temperature mattress within the chamber. The base includes a water circuit, which includes a pump, a water heater, a temperature sensor, and at least one nebulizer. A mixing manifold is secured within the base, which includes the at least one nebulizer, at least one inlet fan and at least one air heater. Water heated by the water heater is nebulized into water particles via the at least one nebulizer and the nebulized water particles are combined with the heated air within the mixing manifold. The combined nebulized water particles and heated air are introduced into the chamber at a controlled rate.

### CROSS-REFERENCE TO RELATED APPLICATIONS

This application claims the benefit of U.S. provisional application No. 63/381,205 filed on Oct. 27, 2022 and is also a continuation-in-part based on U.S. Ser. No. 17/222,133, filed on Apr. 5, 2021, which is pending, which application was a continuation-in-part application based on U.S. Ser. No. 16/367,854, filed on Mar. 28, 2019 (now U.S. Pat. No. 10,966,432), which application claimed the benefit of provisional Application No. 62/649,677, filed on Mar. 29, 2018 (now expired). The entire contents of the above applications are incorporated herein by reference.

### FIELD OF INVENTION

The invention relates to the technical field of infant incubators. Particularly, incubators with an internal chamber that is temperature regulated using nebulized water particles and air, which have been heated to a precise target temperature and humidity.

### BACKGROUND OF THE INVENTION

Infant incubators exist, such as disclosed in U.S. Pat. No. 9,772,634. However, there are numerous drawbacks with existing incubators, even ones that utilize nebulizers as a means for providing water particles into the chamber. For example, the water utilized by the known incubators becomes contaminated as the water does not remain within a closed system once pumped into the incubator. Furthermore, the water is not continually circulated throughout the closed system, so it becomes stagnant and therefore is not ready for immediate use by the nebulizers.

Furthermore, known incubators experience long temperature recovery time, nearly 40 minutes, when ports or walls are opened when accessing an infant. Moreover, existing incubators require additional thermal warming, which typically includes radiant heat from a nearby or overhead heat lamp or light source. As air is a poor conductor of heat, thermal warning lamps must be set to generate temperatures far higher than the desired 38° C. infant temperature. Skin regions of the infant, such as the head or the chest, which are in closer proximity to a heat lamp are exposed to this high level of radiant heat. The greater increase in temperature offers a subsequent risk of burning the infant. Further, such warming methods are prone to errors in placement, duration of use and have resulted in extreme discomfort and even death of the infant.

Furthermore, current incubators are damaging to infant's ears from the use of air compressors in such a closed environment. The damage to an infant's ears at such a young age poses a great risk to one's hearing later in life.

Accordingly, what is needed is an apparatus and a process that heats and cools an incubator chamber without the problems associated with previous infant incubators. In addition, what is needed is an incubator that utilizes nebulizers, wherein the sterile water source remains uncontaminated throughout the entirety of the nebulization process. What is needed is an infant incubator that simultaneously harnesses the precision generation of heated water vapor, which is immediately mixed with air that is precisely heated to the desired target temperature to heat or cool the infant within the incubator chamber. Furthermore, this incubator needs to be highly efficient, thereby removing the need for an air compressor.

### SUMMARY OF THE INVENTION

An incubator and a process for regulating the environment of an incubator. The incubator includes a chamber that is formed when a hood is secured to a base. The infant rests atop a variable temperature mattress within the chamber. The base includes a water circuit, which includes a pump connected to a water heater, a temperature sensor, and a nebulizer assembly. Secured within the circuit between the temperature sensor and the nebulizer assembly is a supply control valve, which directs the heated water to the nebulizer assembly and a return control valve, which bypasses the nebulizer assembly and returns the water to the pump for recirculation through the water heater. The nebulizer assembly includes a controlled series of nebulizers that are secured within a mixing manifold in the base. This manifold includes at least one inlet fan that is flushed with the outside of the base and at least one air heater, which heats air from the inlet fan prior to mixing with the nebulized water particles. A UV-C LED sterilization lamp is secured within the mixing manifold to further sterilize the precisely heated water particles and air before being introduced into the chamber. The combined nebulized water particles and air are injected into the chamber at a controlled rate through an adjustable iris positive stop blade vent by an exhaust fan located on an exterior of the hood.

A process for regulating an environment of the incubator, which includes supplying sterile water to the water circuit, heating the water to a desired end point temperature that is less than 38° C., conveying the heated water to the at least one nebulizer secured within the mixing manifold, nebulizing the heated water into heated water particles, introducing air into the mixing manifold, heating the air within the mixing manifold, combining the heated water particles and heated air within the mixing manifold, and introducing the combined heated water particles and heated air into the chamber.

### BRIEF DESCRIPTION OF THE FIGURES

FIG. 1 is a side perspective view of an incubator, which includes a chamber that is formed via the attachment of a hood to a base.

FIG. 2 is a side, perspective, partially exploded view of the incubator shown in FIG. 1.

FIG. 3 is a flow diagram of a process for regulating the environment of the incubator shown in FIG. 1 utilizing nebulized water particles and air.

FIG. 4 is a schematic diagram of a water circuit utilized by the incubator shown in FIG. 1 to create temperature-controlled water particles.

FIG. 5 is a top view of the structural components utilized by the water circuit shown in FIG. 4.

FIG. 6 is a side view of a water heater utilized by the incubator shown in FIG. 1.

FIG. 7 is a cross-section view of a nebulizer utilized by the incubator shown in FIG. 1.

FIG. 8 is an open-faced view of a mixing manifold secured within the base of the incubator shown in FIG. 1.

### DETAILED DESCRIPTION

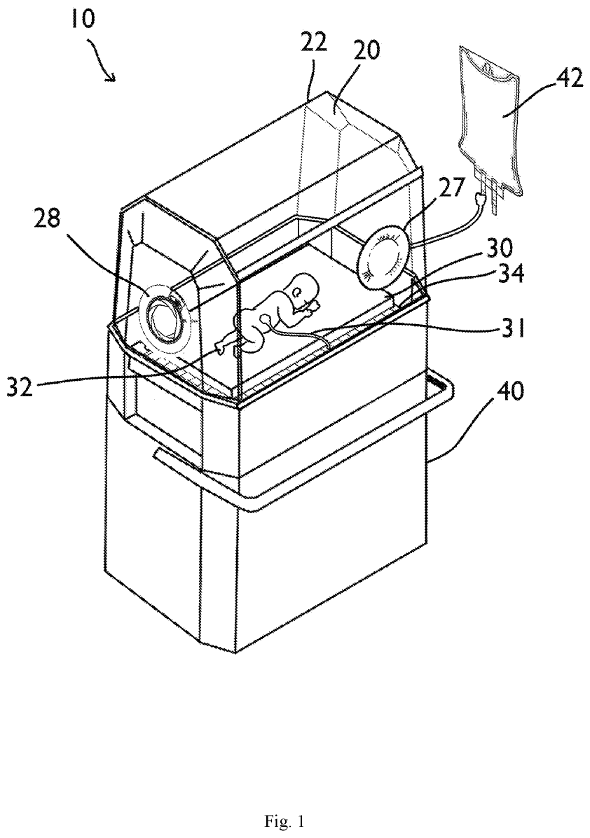

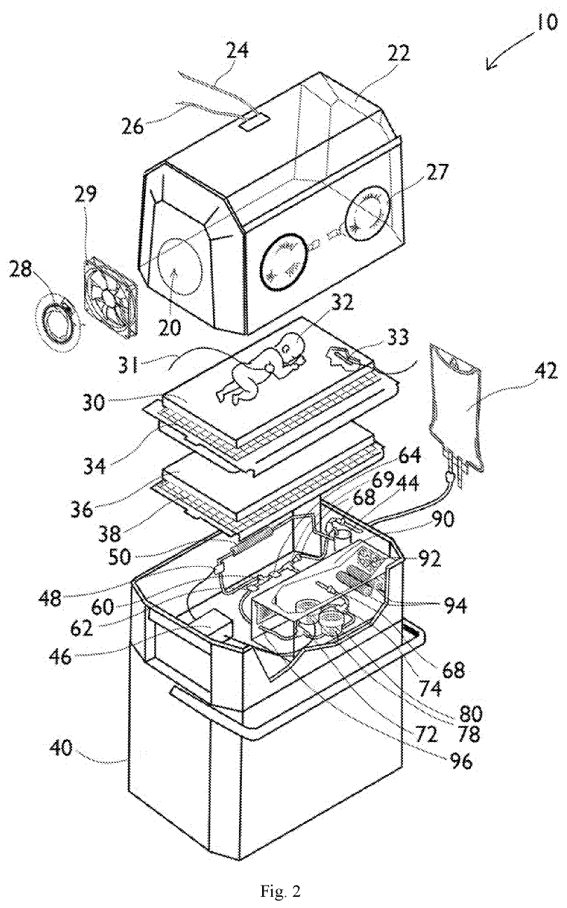

FIGS. 1-2 show an incubator 10 that utilizes nebulized water particles and air to precisely regulate the temperature of an incubator chamber 20. The chamber is formed by the attachment of a chamber hood 22 to a base 40. An infant 32 rests within the chamber atop a variable temperature nebulizer mattress 30, which is situated atop a mattress support frame 34. Secured within the base are the components that create, control, regulate and introduce the temperature-controlled nebulized water particles and air into the chamber.

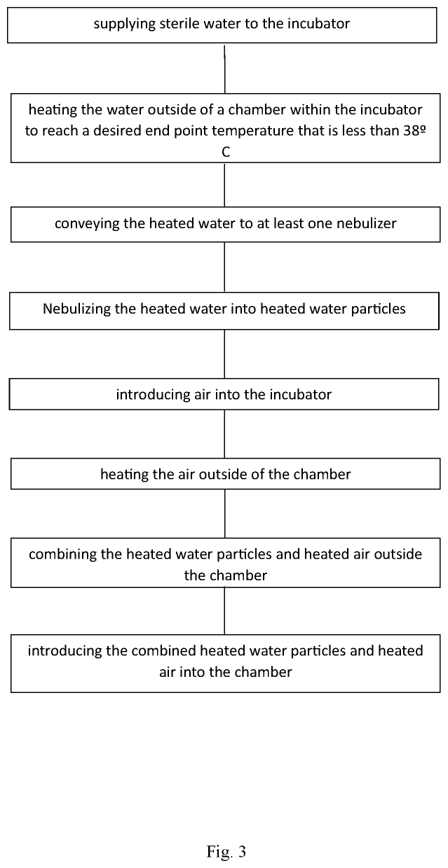

As shown in FIG. 3, the process of regulating and controlling the environment of the incubator 10 includes supplying sterile water from a water source 42 to the water circuit 43, heating the water to a desired end point temperature that is less than 38° C., conveying the heated water to the at least one nebulizer (78, 80) secured within a mixing manifold 90, nebulizing the heated water into heated water particles, introducing air into the mixing manifold, heating the air within the mixing manifold, combining the heated water particles and heated air within the mixing manifold, and introducing the combined heated water particles and heated air into the chamber 20. The incubator utilizes nebulized water particles, compressed air and medicinal gases, if desired, to heat or cool the internal temperature of the chamber. Advantageously, such little water is used by the incubator, and it is so energy efficient, that the nebulized water particles and temperature do not negatively affect the electronics that are secured within the base or the chamber. Furthermore, the process uses a surprisingly small amount of sterile liquid to warm or cool the infant, so the delivery of water vapor is more precise, and the incubator is significantly more energy efficient. As this system requires so little water to operate, the heated water is delivered to the nebulizers nearly instantly with precise temperature and humidity control. This is highly important in warming the infant 32 and is an advantage over prior art methods for incubators as it allows fine control and precise, repeatable consistency in warming the infant incubator to the desired target temperature and humidity. Further, this process safely incubates the infant by avoiding the need for recirculating warmed and humidified air which could easily become injurious to the health of the infant. Due to the even, gentle and pervasive effects of precisely heated nebulized water vapor, this process eliminates the need for additional thermal warming that uses radiant heat from a nearby or overhead heat lamp or light source.

As shown in FIG. 2, the humidity and ambient air temperature of the chamber 20 is measured by a wet-bulb temperature sensor 24 and a dry-bulb temperature sensor 26. These sensors are secured within the chamber, for example to an inner surface of the incubator hood 22. The wet-bulb and dry-bulb temperature sensors continuously sense the wet-bulb and dry-bulb differential to ensure that the chamber is maintaining the preselected temperature and humidity. The temperatures measured by these sensors are relayed to the corresponding wet-bulb and dry-bulb PLDs located within the PLD controls 46 and microprocessor controls for readjustment by a series of thermostatic controllers that monitor and alter the inputs to respective water and air heater circuits located throughout the incubator 10. The incubator has a much faster temperature and vapor recovery rate, for instance, when the ports 29 or doors are opened because the incubator is continuously creating water vapor or particles heated to the desired temperature and continuously introducing this into the incubator chamber under controlled pressure. A user of the incubator determines the desired end point temperature when they manually enter the desired target temperature and humidity or select a predetermined medical program. Present within the incubator are various sensors and probes, such as the temperature sensor 48 within the water circuit 43, which senses the temperature of the water within the water supply circuit and relays this temperature data to a programmable logic device (“PLD”). PLDs are electronic components used to build digital circuits that monitor, control and alter the incubator's temperature. If the temperature within each portion of the incubator is not accurate, the individual monitoring PLDs adjust, readjust, and fine tune the temperature by altering the inputs to the respective heater circuits in the incubator. This control function is implemented either by individual PLD devices or by an algorithm run on a microcontroller, such as with the PLD controls, shown in FIG. 2. For example, the water circuit temperature sensor relays data about the temperature within the water circuit and if the temperature is not where it should be, the PLD automatically adjusts the temperature of the water heater 50 to ensure the water temperature within the nebulizer assembly 70 reaches the precise temperature necessary to generate the nebulized water particles to warm or cool the infant 32 to the desired end temperature. The same is true for the air heater 94 portion of the incubator and correlating control circuitry. This advantageously makes the incubator more energy efficient as it does not have to continually overcompensate for lost heat and humidity in the incubator. The control PLD operation is implemented in hardware using standalone proportional-integral-derivative (PID) controllers or software implementation of the PID algorithm.

As shown in FIGS. 1-2, the chamber 20 also includes an exhaust fan 29, which is secured within a wall of the hood. This fan is, for example, a convection fan, which ensures that the temperature-controlled water vapor, and heated air are evenly dispersed from the base 40 to the chamber to reach all surfaces of the infant 32 and the mattress 30. The temperature-controlled nebulized water particles and air are introduced from the base and into the chamber via negative air pressure created by the exhaust fan and an iris positive stop blade vent 28. The hood additionally includes access ports 27, for accessing the infant without removing the hood and altering the environment of the chamber.

As shown in FIG. 2, secured within the chamber 20 is a variable temperature mattress 30, which is situated atop a support frame 34. The frame is preferably an open mesh grid that is secured atop the base 40. The mattress is preferably made of a thin plastic open frame that is filled with moistened super absorbent polymer material, which is enclosed in an envelope made from a non-woven, non-perforated permeable polyolefin sheet of extremely fine continuous high-density, sterile medical-grade polyethylene (HDPE) or polypropylene fibers. The super absorbent polymer is, for example, composed of 2-propenoic acid polymer, cross-linked w/sodium 2-propenoate (CAS 30 Number: 9033-79-8). This material is activated with a measured amount of pure, de-ionized or distilled water to achieve the desired moisture content and physical volume required to comfortably support the infant 32 whilst being contained inside the envelope whose dimensions are defined by the outside of a plastic frame. The super absorbent polymers maintain their particle shape even under modest pressure. Regulating the amount of moistened polymer material contained in the mattress structure allows the infant to be precisely and gently supported according to medical need, weight, and age. The continuous non-woven, non-perforated sheet of extremely fine continuous high-density polyethylene (HDPE) fibers has the unique property of resisting both bulk, liquid water and air penetration while allowing the nebulized water vapor to pass through the material's surface. One continuous non-woven, non-perforated sheet that is preferable includes a medical grade DuPont Tyvek® 1073B, which has one of the highest permeability ratings of 58 perms, according to the ASTM E96 test. Advantageously, when the number of permeability is higher, the material is better able to pass moisture vapor. So, as the temperature-regulated nebulized water particles and air are introduced inside the chamber, the nebulized water particles penetrate the mattress exterior and influence the water molecules contained in the moistened super absorbent polymer. The temperature of the water molecules inside the moistened super polymer material necessarily increases, quickly matching the temperature of the nebulized water particles and warming the mattress to the desired temperature. The result is that the variable temperature mattress quickly assumes the desired target temperature of the incubator interior, providing additional necessary warmth to the infant. The heated mattress also advantageously acts as a heat sink by retaining its heat even when the hood or ports 27 are opened during medical treatment of the infant. The retained warmth is a beneficial to maintaining the desired temperature of the chamber as less heat is required to reheat the chamber and the infant after the environment is affected. A temperature probe 31 is affixed to the infant to detect the infant's body temperature. A further temperature probe 33 is secured within the mattress to ensure the temperature of the mattress is maintained at an optimal temperature. These temperature probes are electrically connected to the PLD controls 46 and microprocessor controls, which adjust the water and air heater circuits secured within the base to finetune the temperature and humidity accordingly. Further, if desired, the mattress is pre-packaged in a sterile, waterproof overwrap. In addition, if further cushioning is desired, an exterior pillowcase is secured around the mattress and is made of an appropriate cloth material of a desired composition and texture to provide the infant with an absorbent comfortable surface on which to rest.

As shown in FIG. 2, if additional warmth and/or cushioning is required, an additional prewarmed mattress 36 is included beneath the variable temperature mattress 30 and support frame 34. The prewarmed mattress is secured to an additional support frame 38 secured to the base 40. The use of the prewarmed mattress and support frame further quickens the heating of the chamber 20 and the variable temperature mattress to the desired temperature. Furthermore, the prewarmed mattress is easily and immediately replaceable with a new prewarmed mattress should the need arise.

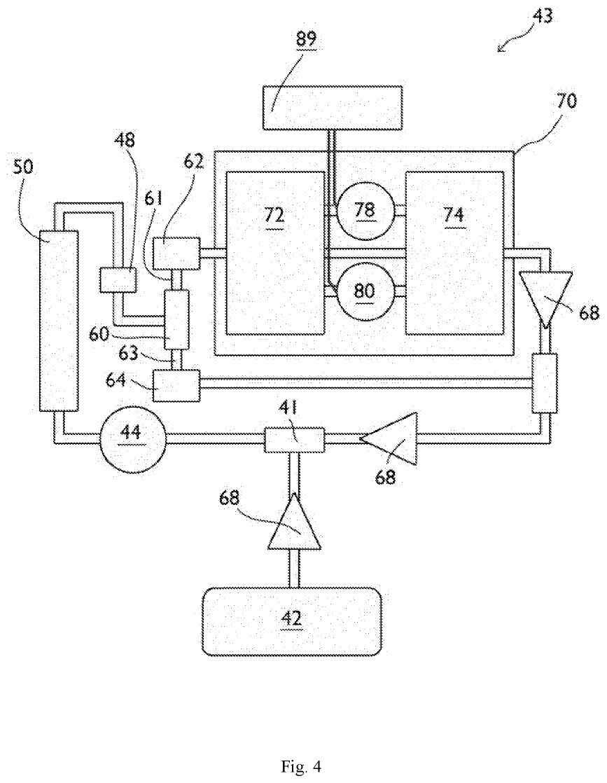

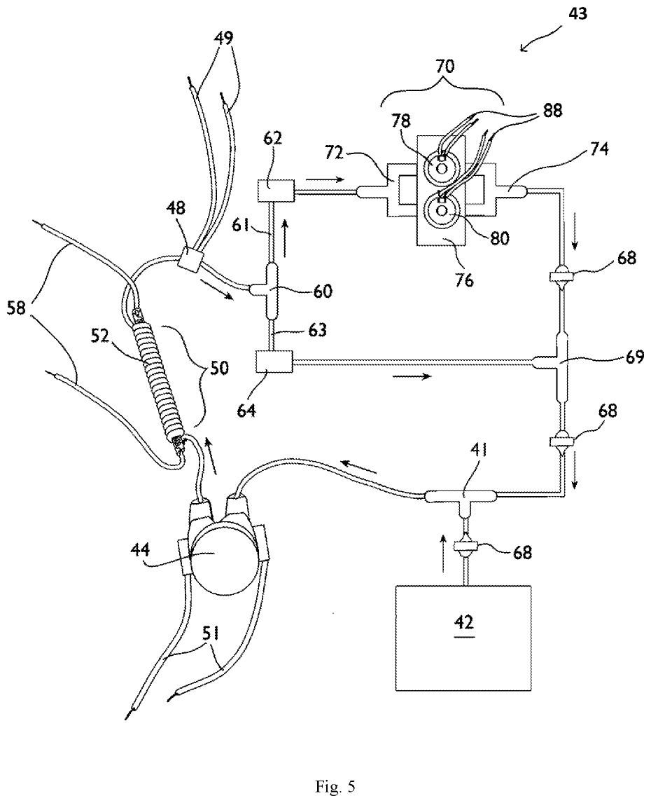

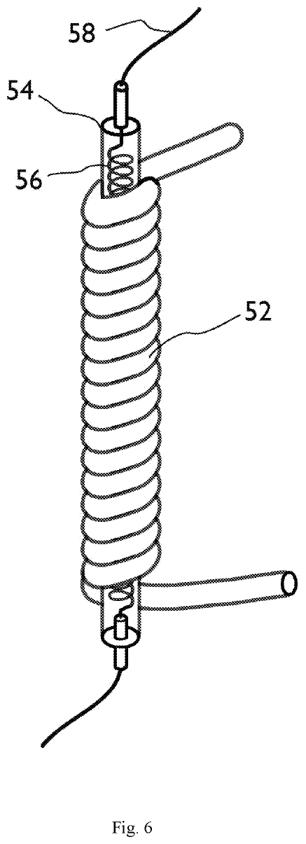

As shown in FIG. 2, secured within the base 40 are various components that work together to create, control, regulate and introduce the temperature-controlled nebulized water particles and air into the chamber 20. The base includes various harmonious assemblies and circuits that are necessary for achieving the desired end point temperature and humidity of the chamber. As shown in FIG. 2, and particularly in FIGS. 4-5, the water circuit 43 that is responsible for creating the nebulized water particles begins with water being pumped into the base from an external water source 42, such as a sterile IV bag. Using sterile bags of desired liquids eliminates a possible source of contamination caused by less than sterile municipal water contained in possibly inadequately cleaned water tanks as employed in known incubators. The water is pumped into the base through an input manifold 41, which is a T connector. The connections throughout the water circuit include standard tubing, such as silicone tubing, connecting each component. This water is pumped throughout the circuit via a pump 44, which is preferably a peristaltic pump, that controls the rate of flow of the water in the water circuit. The pump includes power leads 51 that are connected to a power source that drives the incubator. The power source for the incubator is a 24V, DC power supply, which DC power supply is powered by a 120V AC connection to the building power system via a wall plug. Advantageously, the process requires less electricity than conventional incubators and operates on 24 volts instead of the commonly required 120 volts. The water travels from the pump to a water heater 50, which is secured to a side of the base so that the water heater is not located directly beneath the infant 32 and mattress 30. The water heater is shown more particularly in FIG. 6 and includes coiled aluminum water heater tubing 52 wrapped around a hollow glass rod 54 that contains resistance heating wire 56 such as a copper wire or coiled nichrome wire. The coiled wire includes leads 58, which are electrically connected to a power source and the PLD controls 46 and microprocessor controls. Water flows through the coiled aluminum tubing which is heated to the desired temperature by the resistance wire secured within the glass rod. Advantageously, the coiled nichrome wire is precisely calibrated to the exact desired temperature range by controlling both the diameter and total length of the wire and the current introduced into the wire. This structure of the water heater is advantageous because the rapid heating of the nichrome wire and hollow glass rod tubing nearly instantaneously heats the amount of water flowing through the coiled water heater tubing. The heated water is therefore constantly heated and always ready for immediate use. Since the water is so efficiently and quickly heated to the desired end temperature, the incubator 10 is vastly more efficient than prior incubators.

As shown in FIGS. 2, and 4-5, secured within the water circuit 43 after the water heater 50 is a water temperature sensor 48. This sensor immediately measures the temperature of the water once it leaves the heater. This water temperature sensor is connected via leads 49 to the PLD controls and microprocessor controls for continual monitoring and adjusting of the water temperature. The temperature of the water that is sensed by the water sensor determines the next route that the water takes within the water circuit. After the temperature sensor, the water travels through an input manifold 60, which is a T connector. The input manifold splits the water channel into a supply channel 61 and a return channel 63. The supply channel leads to the nebulizer assembly 70, located outside the chamber 20, and the return channel bypasses the nebulizer assembly and leads back to the pump 44 and the water heater. Secured within the supply channel is a supply valve 62 and secured within the return channel is a return valve 64. After the water flows through the input manifold, these valves dictate whether water flows into the supply or return channels. For example, if the temperature sensor detects that the water leaving the water heater is not at the desired temperature, the supply valve will close and the return valve will open, thereby allowing the water to bypass the nebulizer assembly and return to the water heater through an output manifold 69 for further heating. This cycle will continue until the water is the precise temperature for nebulization, at which point the supply valve will open and the return valve will close. Furthermore, if the temperature and/or humidity of the chamber is at the desired level and no further nebulized water particles are needed, the supply valve will shut off and the water will continue to cycle through the return channel. This is advantageous as this water maintains a constant temperature by passing through the water circuit continuously and the water does not become stagnant as it is constantly moving. Moreover, the water circuit is advantageous because once the sterile water is pumped into the base from the external source, it never leaves the sterile environment of the incubator 10. To further aid in the efficiency of the water circuit, various check valves 68 are secured throughout the circuit to prevent backflow of water into the nebulizers (78, 80), thereby overflowing them. These check valves are located after the sterile water source 42, after the nebulizer assembly, and after the output manifold. The precise location of these check valves aids in the efficiency of the water circuit and leads to very little error caused by unnecessary backflow.

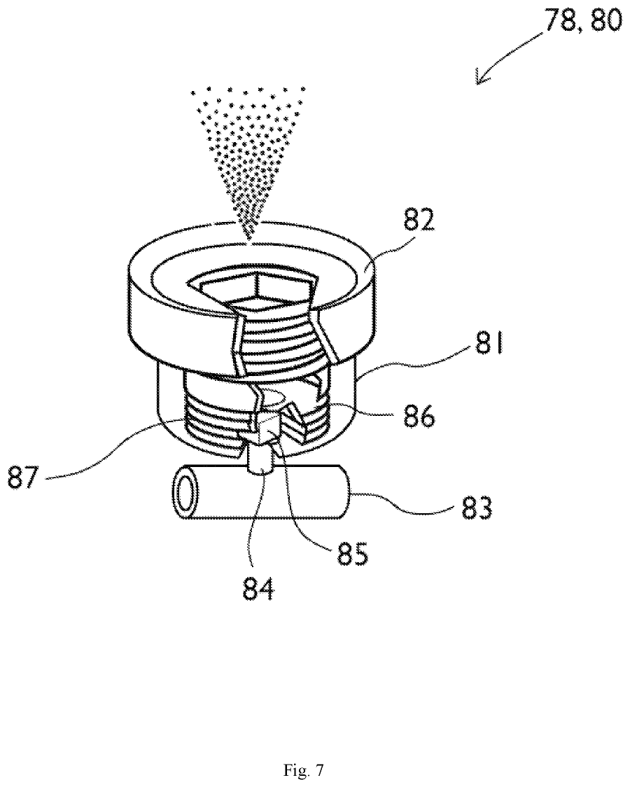

As shown in FIGS. 2, and 4-5, when the supply valve 62 is open, water flows into the supply channel 61, which leads to the nebulizer assembly 70. There are two nebulizers (78, 80) within the nebulizer assembly, so the supply channel includes a y split 71 that splits the water from one channel into two so that there are independent channels flowing to each nebulizer. If more nebulizers are needed, more y splits are used. After the nebulizers is an additional y split 73 that connects the channels from each nebulizer back into a single channel, which leads back to the pump through the output manifold 69. The structure of the nebulizers is shown more particularly in FIG. 7 and is preferably a vibrating mesh nebulizer or ultrasonic nebulizer, preferably a 2.4 MHz system which generates an average particle size of 1-2 microns. These nebulizers operate well above the threshold of human hearing and advantageously do not affect the hearing of the infant. The nebulizers include a threaded assembly holder 81 to which an assembly locking collar 82 secures. This assembly is, for example, secured within a housing, which housing is secured within a mixing manifold 90 within the base 40. The bottom surface of the assembly holder includes an opening for the connection of an extending portion 84 of a feed tube 83, which feed tube is T shaped. If the supply valve 62 is open, water is continuously pumped through the feed tube. Due to the slight pressure created by the water flowing through the feed tube, the precise amount of water is siphoned into the extending portion thereby saturating a wick 85. Advantageously, the size of the extending portion is smaller in diameter than the feed tube portion through which water flows, so the wick does not become oversaturated. The wicking material is advantageous as it is precisely saturated with the heated water, thereby remaining at the correct height and in constant contact with the bottom of a nebulizing disc 86. The nebulizer disc rests upon a wick spacer 87, which is an O-ring, within the cylinder and is secured by the threaded collar that fits snugly within the assembly, holding the nebulizer disc in place. The wick spacer creates a small watertight chamber which contains water at the bottom of the nebulizer assembly ensuring the wick is saturated. The wick spacer also supports the nebulizer and allows the necessary space for the wick to uptake the provided water and produce the aerosol. Accordingly, water that saturates the wick is nebulized via the disc and injected out the top of the nebulizer. Further secured to the nebulizer are nebulizer control leads, which connect to nebulizer electronics 89, the PLD controls 46 and the microprocessor.

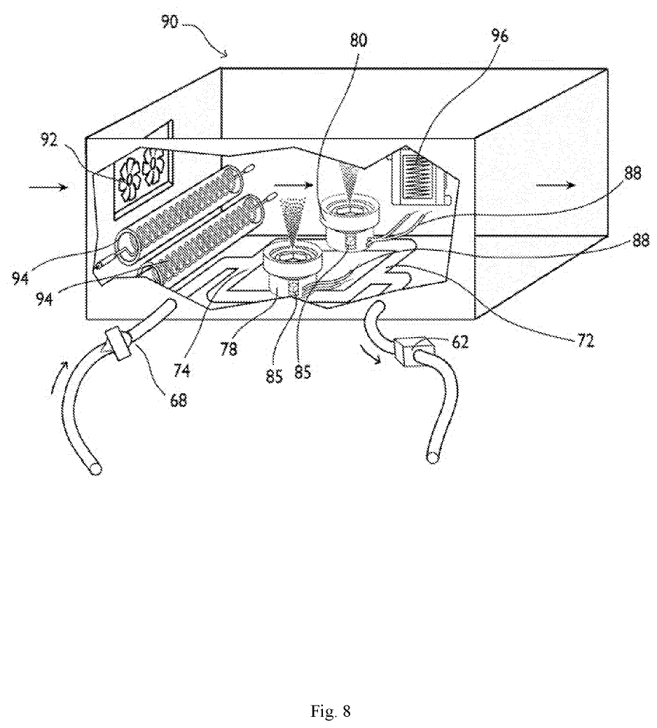

As shown in FIGS. 2 and 8, the nebulizer assembly 70 is secured within a mixing manifold 90. The mixing manifold is secured within the base 40, preferably to a wall of the base, so that an inlet fan 92 is flushed with a wall of the base and is therefore exposed to the outside environment. Secured within the manifold adjacent to the fan are air heaters 94. These heaters, for example, include wires, such as resistance heating wire coils connected to heater power leads which are surrounded by quartz heater tubes. Due to the precise location of the air heaters, the air created from the inlet fan is heated to a precise temperature by flowing around the air heaters via positive air pressure created by a continuously running inlet fan. This way of heating the air is highly efficient as the air is immediately heated to the precise end temperature. Furthermore, if the air requires finetuning, the air heater quickly adjusts to the correct temperature due to the conductivity of the copper wires. The necessary amount of air admitted by the inlet fans is controlled by baffles and the resulting air pressure depends on factors such as the volume of the incubator 10 and chamber 20, the relative size of the air volume being moved throughout the incubator and the speed and swept area of the exhaust fan.

When air is moved through the air heaters 94, it is heated to a temperature calculated to create the desired end point humidity based on the desired target temperature selected by a user of the incubator 10. For example, the web bulb temperature can be derived from the humidity reading by a humidity sensor, or directly by wet bulb sensor 24. When a dedicated humidity sensor is used, information derived therefrom controls the changes to the dry air temperature and aerosol generation as needed to maintain chamber 20 temperature and humidity. Using humidity as the heated air target eliminates the possibility of reaching a dew point that creates condensation within the incubator. In this way, the air, having been precisely heated to the desired target temperature does not cool the heated water as in other prior incubators. Those prior processes necessarily require overheating the water to compensate for the cooler air they use to create a stream of heated humidity to warm the infant 32. Due to the precise positioning of the nebulizer assembly 70 secured within the mixing manifold 90, the heated air mixes with the nebulized water particles within the manifold. The temperature-regulated air and nebulized water particles are advantageously sterilized when combined before being introduced into the chamber by passing through an array of UV-C LED sterilization lamps 96. The UV-C light peaking at around 265 nm is preferred as these lamps have the highest disinfection efficiency against both bacteria and virus. The side of the manifold located opposite of the inlet fans 92 is open, so the temperature controlled nebulized water particles and air are injected into the chamber through this opening due to the positive air pressure which exits through an exhaust port 28 located in the hood 22. As the mattress 30 does not cover the entire surface area of the base, the temperature-controlled air and nebulized water particles are injected around the mattress and into the chamber 20. The length of the mixing manifold is designed to expose the combined heated air and nebulized water to the optimum length of time to provide maximum sterilization before it is admitted into the chamber. The mixing manifold is fully opaque and made of a heat resistant plastic and is precisely positioned to avoid any leakage of the UV-C light into the chamber.

Accordingly, the incubator 10 and process of controlling and regulating the environment thereof, precisely combines air and water vapor, all precisely heated together to the desired target temperature, so the resulting humidity in the incubator is safer, quieter, and more accurate. Additionally, the process also significantly overcomes the currently long temperature recovery time (nearly 40 minutes duration) that all previous incubators experience when ports or walls are opened during access to the infant. Further, the process advantageously imparts the exact desired target temperature to a unique, form-fitting variable temperature mattress 30.

It is well recognized by persons skilled in the art that alternative embodiments to those disclosed herein, which are foreseeable alternatives, are also covered by this disclosure. The foregoing disclosure is not intended to be construed to limit the embodiments or otherwise to exclude such other embodiments, adaptations, variations, modifications and equivalent arrangements.

1. An incubator comprising:
a base;
a hood secured to the base;
a chamber formed between the base and the hood;
a mattress secured within the chamber;
a water heater secured within the base; and
a mixing manifold secured within the base and comprising a first and second end, wherein the first end is flushed with a wall of the base and the second end is open, wherein the manifold further comprises at least one inlet fan secured inside the first end of the manifold, at least one air heater, and at least one nebulizer.

2. The incubator of claim 1, further comprising a UV-C LED sterilization lamp secured within the manifold.

3. The incubator of claim 1, further comprising a controlled exhaust port and an intake fan secured within the hood.

4. The incubator of claim 1, wherein the water heater comprises a coiled tubing wrapped around a hollow glass rod, wherein the glass rod contains a resistance heating wire.

5. The incubator of claim 1, wherein the mattress comprises an open plastic frame filled with a moistened super absorbent polymer material, wherein the polymer material is enclosed in an envelope made from a non-woven, non-perforated permeable polyolefin sheet.

6. The incubator of claim 1, wherein the air heater comprises a resistance wire coil surrounded by a quartz heater tube.

7. The incubator of claim 1, further comprising a pump secured within the base, which pumps water from an external source into the incubator.

8. The incubator of claim 1, further comprising a temperature sensor secured within the base adjacent to the water heater.

9. An incubator comprising:
a base containing a water circuit, wherein the circuit includes a water line connected among a pump, a water heater, and at least one nebulizer;
a hood secured to the base, wherein the hood comprises a controlled exhaust port and an intake fan;
a chamber formed between the base and the hood;
a mattress secured within the chamber; and
a mixing manifold secured within the base and comprises a first and second end, wherein the first end is flushed with a wall of the base and the second end is open, wherein the manifold further comprises at least one inlet fan secured inside the first end of the manifold and at least one air heater.

10. The incubator of claim 9, wherein the water circuit further comprises a temperature sensor secured between the water heater and the at least one nebulizer.

11. The incubator of claim 10, wherein the water circuit further comprises a T connector secured within the water line wherein the T connector splits the water line into a supply channel leading to the at least one nebulizer and a return channel leading back to the pump.

12. The incubator of claim 11, wherein the supply channel includes a supply valve, and the return channel includes a return valve, wherein the supply valve and return valve are closed and opened depending on the temperature of the water measured by the temperature sensor.

13. The incubator of claim 9, wherein the mattress comprises an open plastic frame filled with a moistened super absorbent polymer material, wherein the polymer material is enclosed in an envelope made from a non-woven, non-perforated permeable polyolefin sheet.

14. The incubator of claim 9, further comprising a UV-C LED sterilization lamp secured adjacent to the at least one nebulizer within the mixing manifold.

15. The incubator of claim 9, wherein the water heater comprises a coiled tubing wrapped around a hollow glass rod, wherein the glass rod contains a resistance heating wire.

16. A process for regulating an environment of the incubator of claim 9 comprising:
supplying sterile water to the water circuit;
heating the water to a desired end point temperature that is less than 38° C.;
conveying the heated water to the at least one nebulizer;
nebulizing the heated water into heated water particles;
introducing air into the mixing manifold;
heating the air within the mixing manifold;
combining the heated water particles and heated air within the mixing manifold; and
introducing the combined heated water particles and heated air into the chamber.

17. The process of claim 16, wherein the water is heated by transferring it through the water heater, which includes a coiled tubing wrapped around a hollow glass rod, wherein the glass rod contains a resistance heating wire.

18. The process of claim 16, wherein the air is heated by transferring it around the least one air heater coil before reaching the nebulizer.

19. The process of claim 16, further comprising sterilizing the heated water particles and air before being introduced into the chamber via a UV-C LED sterilization lamp secured within the mixing manifold.

20. The process of claim 16, wherein the combined heated water particles and air are introduced into the chamber via positive air pressure created by an intake fan and a controlled exhaust port secured within the hood of the incubator.
